(19) United States
(12) Patent Application Publication
(10) Pub. No.: US 2013/0247554 A1
(43) Pub. Date: Sep. 26, 2013

(54) Remotely Controlled Vehicle Pedal Actuator

(71) Applicants: James Henry Cooper, Fresno, CA (US); Armen Petrosyan, Fresno, CA (US)

(72) Inventors: James Henry Cooper, Fresno, CA (US); Armen Petrosyan, Fresno, CA (US)

(21) Appl. No.: 13/427,823

(22) Filed: Mar. 22, 2012

(51) Int. Cl. F15B 13/042; F15B 15/00

(52) U.S. Cl. 60/470; 91/418; 60/407

(57) ABSTRACT

The Remotely Controlled Vehicle Pedal Actuator is a pneumatically powered tool for use in the motor vehicle repair and maintenance industry that enables a mechanic to solely, remotely, and repetitively depress and retract a vehicle accelerator, clutch or brake pedal. The device comprises a pneumatic linear actuator (commonly termed an air cylinder) that is pneumatically connected to a foot, hand or electronically activated pneumatic valve and a pneumatic power source. One end of the actuator is attached to a vehicle steering wheel with the opposite end attached to the vehicle accelerator, clutch or brake pedal. Activating the pneumatic valve pressurizes the actuator causing the actuator rod arm to extend and depress the vehicle pedal. Deactivating the pneumatic valve depressurizes the actuator causing the actuator rod arm to withdraw and retract the vehicle pedal.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The vehicle repair and maintenance industry often involves work on fuel, drive train, or brake systems that require a vehicle accelerator, clutch or brake pedal be depressed and retracted while making observations, adjustments or repairs. Present practice in the industry requires an assistant sitting in the driving seat to depress and retract a vehicle pedal upon command from a mechanic making observations or repairs or doing maintenance work. This practice is time consuming, wasteful and, also, difficult when the repair and maintenance work requires raising the vehicle on a lift. Prior art (U.S. Pat. No. 8,093,994) acknowledges the wasteful nature of an assistant in a brake line bleeding process, however, the prior art, described essentially as a spring loaded device, would require a mechanic return to the driving compartment to manually reset the device, manually retract the brake pedal, potentially enter the driving compartment with greasy hands, clothes and shoes, and with a vehicle in a raised position, additionally lower and raise the vehicle for each resetting and retracting.

### BRIEF SUMMARY OF THE INVENTION

The general idea behind the Remotely Controlled Vehicle Pedal Actuator is to enable vehicle mechanics the capacity to repetitively, solely, and remotely control, with hand held or foot pedal mechanism, the occurrence and frequency of depressing and retracting a vehicle accelerator, clutch or brake pedal. The Remotely Controlled Vehicle Pedal Actuator is a tool that solves problems encountered in the vehicle repair and maintenance industry that involves the need for depressing and retracting either a vehicle accelerator, clutch or brake pedal. Sources of problems solved include: the need for an assistant; the need for an assistant or mechanic to enter the driving compartment with greasy hands, clothes or shoes; poor communications between mechanic and assistant in a noisy garage (exacerbated when the vehicle is raised on a lift); idleness of an assistant waiting for instructions especially when the vehicle is lifted; as well as, those problems mentioned in the ‘Background of the Remotely Controlled Vehicle Pedal Actuator’ in reference to prior art.

### BRIEF DESCRIPTION OF THE SEVERAL VIEWS OF THE DRAWING

FIG. 1 and FIG. 2 include general side view representation of the Remotely Controlled Vehicle Pedal Actuator.

FIG. 3 includes identifying essential components in an exploded side view.

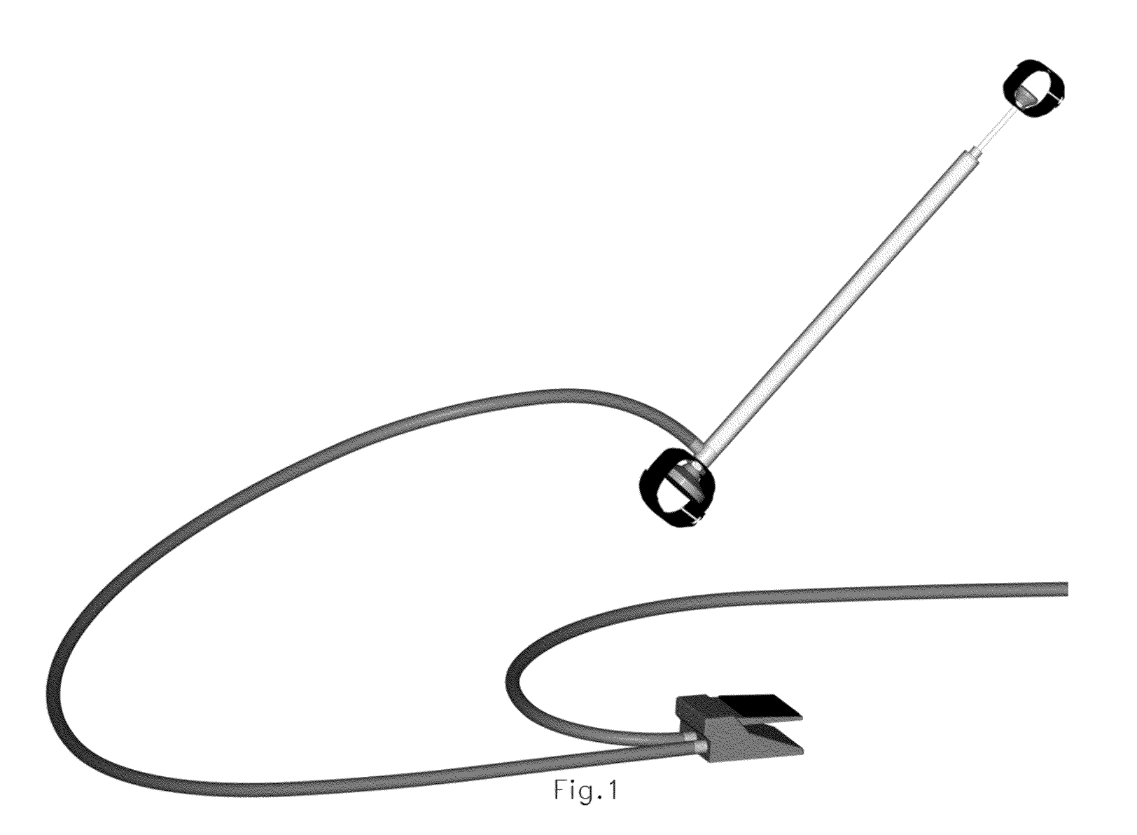

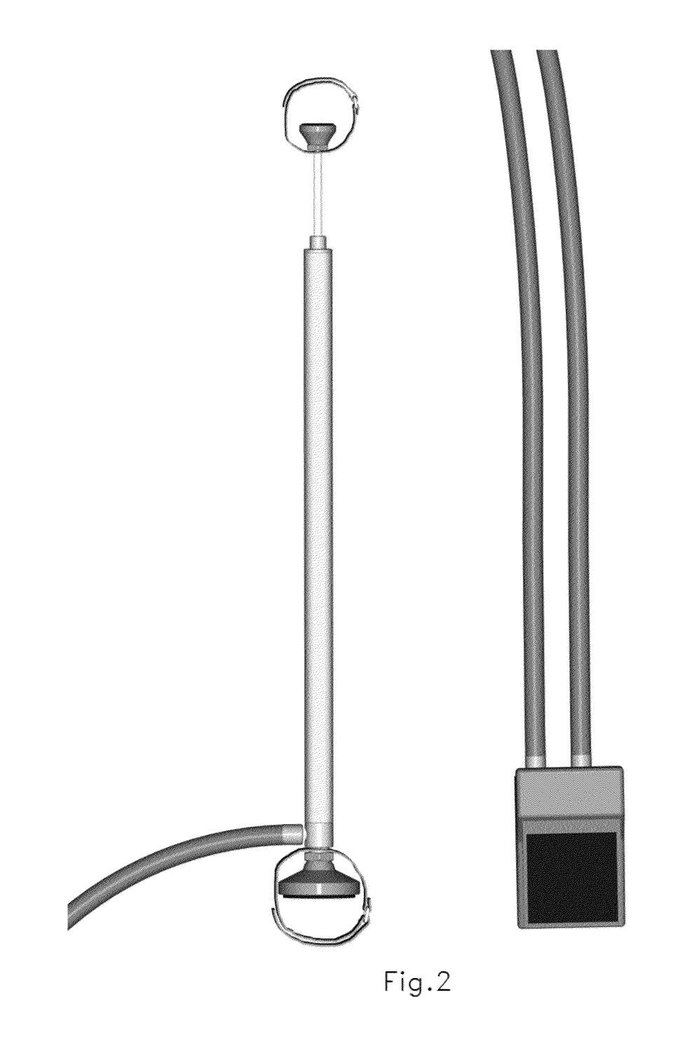

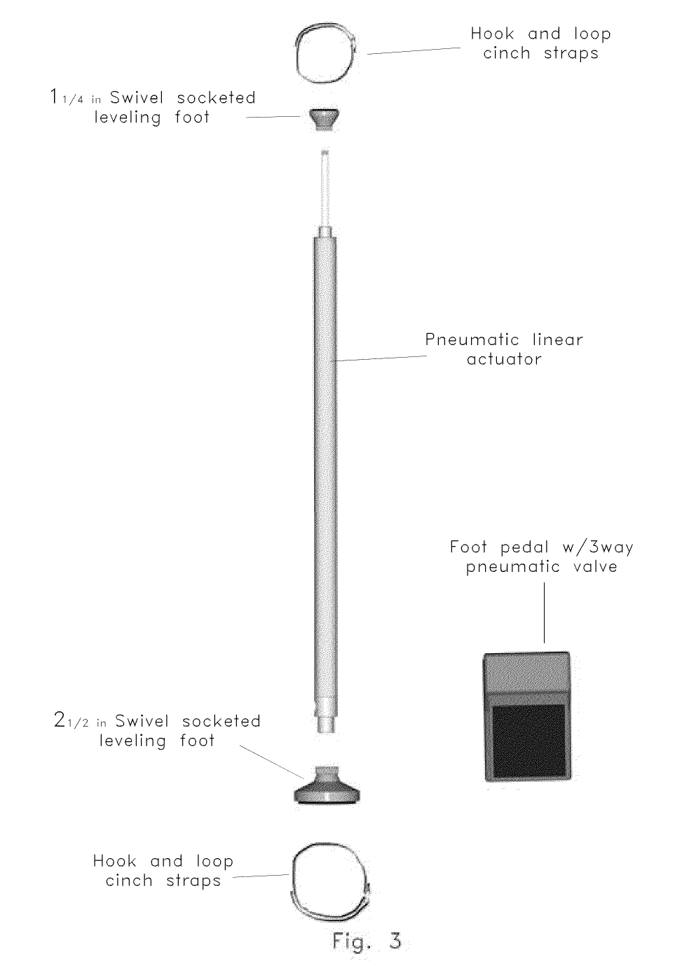

### DETAILED DESCRIPTION OF THE INVENTION

The Remotely Controlled Vehicle Pedal Actuator is a pneumatic tool tied to a vehicle steering wheel and either an accelerator, clutch, or brake pedal. When pneumatic pressure is applied to the device the vehicle pedal depresses and when pneumatic pressure is removed the pedal retracts.

Essential components of the Remotely Controlled Vehicle Pedal Actuator include: a pneumatic linear actuator, a foot, hand or electronically activated three way pneumatic valve, pneumatic hose and various pneumatic fittings, swivel socketed leveling pads, and hook and loop cinch straps.

The pneumatic linear actuator (commonly termed an air cylinder) used to build a prototype Remotely Controlled Vehicle Pedal Actuator is a standard marketplace single acting, ¾ inch bore with a rod arm diameter of ¼ inch and stroke of about 10 inches. The overall length (not including the rod arm) is around 19 inches. (Standard marketplace pneumatic linear actuators with similar bore size, overall length, and rod arm stroke are generally interchangeable from the various pneumatic linear actuator manufacturers). Additional and atypical specifications of the pneumatic linear actuator are as follows: 304 stainless tube (which for the prototype is covered with a shrink wrap sleeve to prevent accidental damage from normal use), clear anodized aluminum end caps, sintered bronze rod bushing, ⅛ inch NPT port threads, maximum pressure of 250 psi, a spring force of three pounds installed and six pounds compressed, and rod arm specifications of 303 stainless steel, ¼ inch diameter, 7/32 inch flats, and ¼-28 NPT threaded rod arm end. Also, the end of the pneumatic linear actuator, opposite the rod arm end, is provided with a ⅝-18 NPT threaded mounting post.

A foot, hand or electronically activated three way pneumatic valve is connected with ½ inch air hose and various fittings between the pneumatic power source and the pneumatic linear actuator. The prototype Remotely Controlled Vehicle Pedal Actuator employs a foot pedal attached to a 3 way pneumatic valve with ¼ inch NPT ports. The foot pedal was chosen over a hand held type, as it is hands free; however, hand held types, including a palm button and remote fob, were built and tested and are manageable. Three way pneumatic foot or hand activated valves are readily available in the marketplace. The remote fob type was assembled and constructed of readily available components comprising a battery pack, a remote fob with receiver and sender, and an electronic 3 way pneumatic valve.

The pneumatic hose, minimum 250 psi, and various fittings, the swivel socketed leveling pads, and the hook and loop cinch straps are readily available in the marketplace.

Two swivel socketed leveling pads are used on the prototype Remotely Controlled Vehicle Pedal Actuator. Both are made of steel but are two different sizes with different female threaded connectors. Steel is chosen over plastic types due to its durability. One of the two swivel socketed leveling pads has a diameter of 1¼ inches, an overall height of one inch including an elastomer pad, and a ¼-28 NPT threaded female connector. The second swivel socketed leveling pad has a diameter of 2½ inches, an overall height of 1¼ inches (without elastomer pad), and a ⅝-18 NPT threaded female connector. The swivel socketed leveling pads allow for a more direct alignment of the pneumatic linear actuator between the vehicle steering wheel and either an accelerator, clutch, or brake pedal. The swivel socketed leveling pads, also, secure the hook and loop cinch straps to the pneumatic linear actuator as described below.

The hook and loop cinch straps that tie the pneumatic linear actuator to the vehicle steering wheel and either an accelerator, clutch or brake pedal are of two sizes and number. One hook and loop cinch strap is used to affix the pneumatic linear actuator to the vehicle steering wheel and two are used to affix the pneumatic linear actuator to either the accelerator, clutch, or brake pedal. The hook and loop cinch straps are made of heavy duty material and about 1½ inches wide. Measured from the hook and loop cinch strap tip to cinch ring, one hook and loop cinch strap is about 10 inches long and two hook and loop cinch straps are about 16 inches long.

The 10 inch hook and loop cinch strap affixes the pneumatic linear actuator to the vehicle steering wheel and the two 16 inch hook and loop cinch straps affix the pneumatic linear actuator to the either the vehicle accelerator, clutch, or brake pedal. The hook portion of the hook and loop cinch straps, measured from the tip, are about 3½ inches long.

A ¼ inch grommet is installed near the center of the 12 inch hook and loop cinch strap at a point about 2½ inches from the cinch ring.

With the two 16 inch hook and loop cinch straps crossing at about 90 degrees and about 2½ inches from the cinch rings, a ⅝ inch grommet is installed through both straps near the center of the 90 degree crossing.

The hook and loop cinch straps are attached to the pneumatic linear actuator through the installed grommets.

The ¼ inch grommet of the 10 inch hook and loop cinch strap fits over the ¼ inch diameter rod arm of the pneumatic linear actuator and is secured by screwing the 1¼ inch diameter swivel socketed leveling pad onto the ¼-28 NPT threaded end of the rod arm. Prior to fitting the ¼ inch grommet over the rod arm end, a ¼-28 NPT nut and ¼ inch washer are fitted onto the rod arm to prevent the ¼ inch grommet from slipping past the threaded portion of the rod arm.

The ⅝ inch grommet of the two 16 inch hook and loop straps joined at around 90 degrees by the ⅝ inch grommet fits over the ⅝-18 NPT threaded mounting post of the pneumatic linear actuator and secured by screwing the 2½ inch diameter swivel socketed leveling pad onto the ⅝-18 NPT threaded mounting post.

After attaching and securing the hook and loop cinch straps to the pneumatic linear actuator, the Remotely Controlled Vehicle Pedal Actuator is nearly complete. What remains is to assemble and connect the pneumatic lines that connect the pneumatic linear actuator to the foot pedal activated three way valve and the pneumatic power source. The prototype Remotely Controlled Vehicle Pedal Actuator utilizes ½ inch pneumatic hose minimum 250 psi, brass pneumatic fittings and disconnects. The pneumatic hose, fittings and disconnects are readily available in the marketplace. The length of pneumatic hose leading from the foot pedal to the pneumatic linear actuator is around 18 feet.

It should be noted that the bore size of the pneumatic linear actuator was carefully selected as some vehicle repair and maintenance facilities have pneumatic power sources that may range from 100 psi to as high as 200 psi. At 100 psi, the ¾ inch bore pneumatic linear actuator develops a force of around 44 pounds which is more than sufficient to depress either a vehicle accelerator, clutch or brake pedal. At 200 psi, the ¾ inch bore pneumatic linear actuator develops a force of about 88 pounds which is well below a vehicle steering wheel bending capacity. A 1 inch bore pneumatic linear actuator at 200 psi develops a force of 160 pounds which is excessive for the purposes of the Remotely Controlled Vehicle Pedal Actuator and near vehicle steering wheel bending capacity. A ⅝ inch bore pneumatic linear actuator, at 100 psi, develops a reasonable force of about 30 pounds but the frailty of a standard 3/16 inch diameter rod arm is questionable.

Hydraulic and/or electric powered linear actuators are available but, at this time, were not considered in lieu of pneumatic linear actuators. Hydraulic and/or electric powered linear actuators were considered to be too powerful; potentially causing damage to either a vehicle steering wheel or accelerator, clutch, or brake pedal. Additionally, hydraulic powered linear actuators have the potential for leaking hydraulic fluid into a vehicle driving compartment and electric powered linear actuators have the potential of short circuiting inside a vehicle driving compartment.

The overall length of the Remotely Controlled vehicle pedal Actuator (approximately 21½ inches) is also an important aspect as it must fit between vehicle pedals to steering wheel separations. Vehicle steering wheel to vehicle pedals separations range from around 22 to 25 inches depending on the steering wheel tilt aspects. The prototype Remotely Controlled Vehicle Pedal Actuator was designed for these separations. The flexibility of the Remotely Controlled Vehicle Pedal Actuator is in the pneumatic linear rod arm which extends to fit the separations between a vehicle steering wheel and either an accelerator, clutch, or brake pedal.

Using the Remotely Controlled Vehicle Pedal Actuator is relatively self-explanatory. Attach the hook and loop cinch strap of the rod arm end of the pneumatic linear actuator to the vehicle steering wheel and attach the opposite end to either a vehicle accelerator, clutch or brake pedal with the two hook and loop cinch straps. Connect the power source to the foot pedal activated three way pneumatic valve with pneumatic hose. Then connect the foot pedal activated three way pneumatic valve to the pneumatic linear actuator with pneumatic hose. Push the foot pedal down and the vehicle pedal depresses; let up on the foot pedal lever and the vehicle pedal retracts.

We claim:

1. A Remotely Controlled Vehicle Pedal Actuator for remotely, solely, and repetitively depressing and retracting either a vehicle accelerator, clutch or brake pedal for vehicle repair and maintenance purposes comprising; a pneumatic linear actuator that attaches to a vehicle steering wheel and either the vehicle accelerator, clutch or brake pedal and pneumatically connected with air hose through a foot, hand or electronically activated pneumatic valve to a pneumatic power source, such that, activating the hand, foot or electronically activated pneumatic valve pressurizes the linear pneumatic actuator causing a pneumatic linear actuator rod arm to extend and depress either the vehicle accelerator, clutch or brake pedal, while deactivating the pneumatic valve depressurizes the linear pneumatic actuator causing the pneumatic linear actuator rod arm to withdraw and retract either the vehicle accelerator, clutch, or brake pedal.

2. The Remotely Controlled Vehicle Pedal Actuator of claim 1, further comprising a swivel socketed leveling foot attached to one end of the pneumatic linear actuator and a swivel socket leveling foot attached to the opposite end of the pneumatic linear actuator.

3. The Remotely Controlled Vehicle Pedal Actuator of claim 1, further comprising hook and loop cinch straps for attaching the pneumatic linear actuator to the vehicle steering wheel and either the vehicle accelerator, clutch or brake pedal.

4. The Remotely Controlled Vehicle Pedal Actuator of claim 1, wherein the bore size of the pneumatic linear actuator is such that the pneumatic power source will not develop a force above the steering wheel bending capacity.

5. The Remotely Controlled Vehicle Pedal Actuator of claim 1, wherein the length of the pneumatic linear actuator with a swivel socketed leveling foot attached to each end does not exceed the vehicle steering wheel to vehicle accelerator, clutch, or brake pedal separation.

6. The Remotely Controlled Vehicle Pedal Actuator of claim 1, wherein a vehicle mechanic is enabled to repetitively, solely, and remotely depress and retract either a vehicle accelerator, clutch or brake pedal.
